(19) United States
(12) Patent Application Publication
(10) Pub. No.: US 2011/0258646 A1
(43) Pub. Date: Oct. 20, 2011

(54) OPTICAL PICKUP SUPPORTING DEVICE AND OPTICAL DISC APPARATUS INCLUDING THE SAME

(75) Inventors: Takeshi AOKI, Ota-shi (JP); Hisayuki Itoh, Ota-shi (JP)

(73) Assignee: SANYO Electric Co., Ltd., Moriguchi-shi (JP)

(21) Appl. No.: 13/086,200

(22) Filed: Apr. 13, 2011

(30) Foreign Application Priority Data
Apr. 14, 2010 (JP) 2010-093145

(51) Int. Cl. G11B 7/08

(52) U.S. Cl. 720/660; G9B/7.041

(57) ABSTRACT

Provided is a low-cost, high-accuracy optical pickup supporting device by simplifying a structure for fixing guide shafts to a chassis. To this end, an optical pickup supporting device includes: a frame-shaped chassis; a first guide shaft and a second guide shaft, two ends of each of which are fixed to the chassis; an optical pickup device movably supported by the two guide shafts; and a spindle motor fixed to the chassis with a motor supporting member interposed in between. Furthermore, in a first fixation region in which the first guide shaft is fixed to the chassis, the position of the first guide shaft is fixed with higher accuracy by: a fixation area obtained by protruding parts of the chassis; and a position regulating portion which is a part of the motor supporting member.

This application claims priority from Japanese Patent Application Number JP 2010-093145 filed on Apr. 14, 2010, the content of which is incorporated herein by reference in its entirety.

### BACKGROUND OF THE INVENTION

1. Field of the Invention

The invention relates to an optical pickup supporting device for moving an optical pickup device, which is configured to perform a reading operation and a recording operation on an optical disc, in a predetermined direction, and an optical disc apparatus including the same.

2. Description of the Related Art

Widely used are optical disc apparatuses each capable of performing a signal reading operation and a signal recording operation by casting laser light emitted from the optical pickup device on a signal recording surface of the optical disc.

In general, widely-used optical disc apparatuses are of a type using optical discs which are termed as compact discs (CDs) and digital versatile discs (DVDs). Recently, optical disc apparatuses of a type which uses optical discs in compliance with the Blu-ray standard for making the recording density much higher have been developed.

An optical pickup device installed in an optical disc apparatus is configured to be moved in a radial direction of an optical disc by a rotational driving force of a pickup feeding motor. In addition, such an optical pickup device is required to accurately read signals which are recorded in the optical disc. To this end, the optical pickup device is required to precisely carry out its own moving operation in the radial direction of the optical disc. For this reason, the optical pickup device is generally constructed in a way that its moving operation is guided by a pair of guide shafts fixed to a fixation board. (This technology is described in Japanese Patent Application Publication No. Hei 11-66767.)

Furthermore, the positions of the respective guide shafts are held by a frame-shaped chassis formed from a metal plate (this technology is described in Japanese Patent Application Publication No. 2003-208767). To put it specifically, referring to FIG. 1A of Japanese Patent Application Publication No. 2003-208767, the two near-end portions of each of the two guide shafts are fixed to a chassis 11 while adjusted to their respective predetermined positions by use of fastening means such as screw mechanisms. Because the guide shafts are attached to the chassis with the fine adjustment applied to the guide shafts by use of the screws, the optical pickup device is capable of performing the reading operation and the recording operation accurately.

### SUMMARY OF THE INVENTION

### Problems to be Solved by the Invention

The foregoing optical disc apparatuses include those using the various types of optical discs, such as a CD standard optical disc, a DVD standard optical disc and a Blu-ray standard optical disc, as described above. Furthermore, such optical disc apparatuses include those of a stationary type and those of a type installed in computer apparatuses.

Among personal computers, particularly, note-type computers are made thinner. Accordingly, optical disc apparatuses of a type installed in such computers are made thinner as well. When optical disc apparatuses are made thinner, optical pickup devices installed in the optical disc apparatuses are also required to be made thinner.

In addition, Blu-ray standard optical disc apparatuses capable of performing a higher-density recording operation have recently become widely in use. Optical pickup devices installed in such optical disc apparatuses are required not only to have higher precision in itself, but also to secure higher movement accuracy for a driving mechanism configured to perform displacement operations in the radial direction.

A mechanism for fixing the guide shafts to the chassis formed from a metal plate by pressing the guide shafts by use of plate springs has been heretofore adopted as a method of securing positional accuracy for this movement mechanism. However, this mechanism allows vibrations, which occur from a motor configured to move a pickup, to be transmitted to the optical pickup device via the chassis and the guide shafts. This makes the optical pickup device likely to malfunction due to the vibrations.

Moreover, this structure needs plate springs and screw mechanisms for fixing the guide shafts to the chassis in addition to the chassis. The use of these parts increases the number of parts and the number of steps included in the manufacturing process.

Accordingly, when the chassis of the optical disc apparatus is formed from a metal plate whose thickness is approximately 1 mm, the optical disc apparatus in itself is likely to become heavier in weight.

The invention has been made with these problems taken into consideration. An object of the invention is to provide a low-cost, high accuracy optical pickup supporting device by simplifying a structure for fixing the guide shafts to the chassis, and an optical disc apparatus including the same.

### Means for Solving the Problems

An optical pickup supporting device according to the present invention comprises: a chassis; an optical pickup device for casting laser light on an optical recording medium, and detecting the laser light reflected off the optical recording medium; a first guide shaft inserted through a guide hole provided in the optical pickup device, two near-end portions of the first guide shaft being fixed to the chassis; a second guide shaft inserted through a guide groove provided in the optical pickup device, two near-end portions of the second guide shaft being fixed to the chassis; and a motor supporting member for rotatably fixing a spindle motor to the chassis, the spindle motor being configured to rotate the optical recording medium, wherein one of the two near-end portions of the first guide shaft is pressingly fixed to a position regulating portion by use of a fixation area continuing integrally with the chassis, the position regulating portion provided in the motor supporting member.

### Effects of the Invention

In the optical pickup supporting device of the embodiment of the invention, one near-end portion of the first guide shaft for movably supporting the optical pickup device is pressingly fixed to the position regulating portion of the motor supporting member by use of the fixation area continuing integrally with the chassis, the motor supporting member provided for supporting the motor. Thereby, the part of the chassis has a role of fixing the guide shaft to the chassis, and makes the above-mentioned plate spring or screw mechanism for fixing the guide shafts no longer necessary. As a result, the parts and manufacturing steps are reduced in number, and the costs reduction can be accordingly achieved.

Furthermore, in the embodiment of the invention, the chassis and the fixation area are integrally injection-molded out of a resin material. Thereby, the guide shaft is lightly pressed to the position regulating portion of the motor supporting member by the fixation area formed from the resin material which is more flexible than a metal material. As a result, vibrations caused by the rotation of the motor are absorbed by this fixation area, and the vibrations are thus restrained from being transmitted to the optical pickup device. This stabilizes the operation of the optical pickup device.

Moreover, because the chassis which is a main component of the optical pickup supporting device is formed from the resin material which is light in weight, the optical pickup supporting device as a whole is made lighter in weight than any optical pickup supporting device of the conventional example in which the chassis is formed from a metal plate.

Additionally, the position of the first guide shaft is determined by the position regulating portion provided in the motor supporting member connected to the motor. This much enhances the positional accuracy between the first guide shaft and the motor.

### BRIEF DESCRIPTION OF THE DRAWINGS

FIGS. 1A and 1B are views showing an optical pickup supporting device of an embodiment of the invention. FIG. 1A is a perspective view showing the optical pickup supporting device placed in a way that a surface through which to expose an objective lens of an optical pickup device is face up. FIG. 1B is a perspective view showing the optical pickup supporting device of FIG. 1A placed upside down.

FIG. 2 is a perspective view showing a part of the optical pickup supporting device of the embodiment of the invention in a focused manner.

FIGS. 3A and 3B are views showing a motor unit installed in the optical pickup supporting device of the embodiment of the invention. FIG. 3A is a perspective view showing the motor unit installed in the optical pickup supporting device of the embodiment of the invention. FIG. 3B is a cross-sectional view showing the motor unit.

FIGS. 4A to 4E are views showing parts of the optical pickup supporting device of the embodiment of the invention. FIG. 4A is a perspective view showing a first fixation region of a chassis. FIG. 4B is a perspective view showing the chassis in which various components of the optical pickup device and the like are installed. FIGS. 4C to 4E are cross-sectional views showing the first fixation region in detail.

### DESCRIPTION OF THE INVENTION

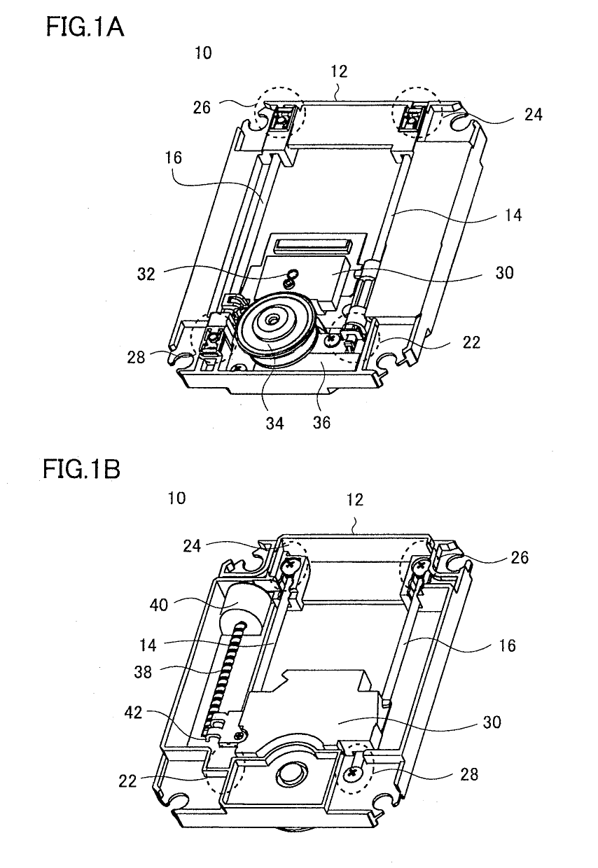

Referring to FIGS. 1A and 1B, descriptions will be provided for a configuration of an optical pickup supporting device 10 of the embodiment. FIG. 1A is a perspective view showing the optical pickup supporting device 10 placed in a way that an objective lens 32 of an optical pickup device 30 is face up. FIG. 1B is a perspective view showing the optical pickup supporting device 10 of FIG. 1A placed upside down.

Referring to FIG. 1A, the optical pickup supporting device 10 includes: a chassis 12 shaped like a frame or casing; a first guide shaft 14 and a second guide shaft 16, the two ends of each of which are fixed to the chassis 12; the optical pickup device 30 movably supported by the two guide shafts; and a spindle motor 34 fixed to the chassis 12 with a motor supporting member 36 interposed in between.

The optical pickup supporting device 10 projects laser light on an optical disc (an optical recording medium) rotated by the spindle motor 34 through the objective lens 32 of the optical pickup device 30. Subsequently, the optical pickup supporting device 10 reads laser light reflected off an information recording layer of the optical disc by use of a photodiode integrated circuit (PDIC) built in the optical pickup device 30. In this respect, laser light in compliance with the Blu-ray disc (BD) standard, the digital versatile disc (DVD) standard or the compact disc (CD) standard is adopted as the laser light to be emitted from the optical pickup device. Similarly, any one of these standards is adopted as a standard for the optical disc rotated by the spindle motor 34.

An optical disc apparatus is made up by housing the thus-configured optical pickup supporting device 10 in a case formed in a predetermined shape.

The chassis 12 is injection-molded out of a resin material, and is shaped like a frame. The chassis 12 has a function of integrally supporting the constituent elements of the optical pickup supporting device 10. A polycarbonate, a modified-PPE (polyphenylene ether) or an acrylonitrile butadiene styrene (ABS) resin is used as the resin material to be made into the chassis 12. Otherwise, a resin material filled with glass fibers may be used as the material of the chassis 12. Incidentally, the four corners of the chassis 12 are provided with the respective cut-away portions for mounting the chassis 12 on a case of the optical disc apparatus by use of fastening means such as screws.

The first guide shaft 14 and the second guide shaft 16 are members for supporting the optical pickup device 30 movably in a radial direction of the optical disc. To this end, the first guide shaft 14 and the second guide shaft 16 are arranged in parallel to the radial direction of the optical disc in a plan view, and concurrently in parallel to an information recording surface of the optical disc as well. It should be noted that the first guide shaft 14 and the second guide shaft 16 are made of a bar-shaped metal material such as a stainless steel. In this respect, the first guide shaft 14 and the second guide shaft 16 will be respectively referred to as a “main guide shaft” and an “auxiliary guide shaft” from time to time.

The two near-end portions of the first guide shaft 14 are attached to the chassis 12 by use of a first fixation region 22 and a second fixation region 24, respectively. The two near-end portions of the second guide shaft 16 are attached to the chassis 12 by use of a third fixation region 26 and a fourth fixation region 28, respectively.

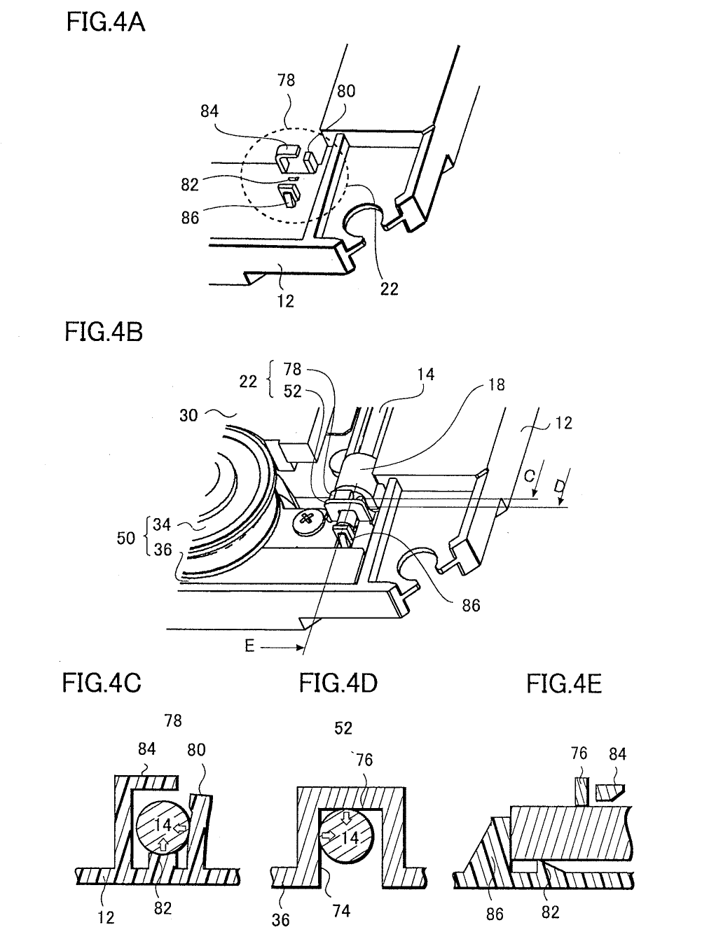

Referring to FIG. 1A, in the second fixation region 24, the third fixation region 26 and the fourth fixation region 28, the guide shafts are fixed to the chassis 12 by use of a screw mechanism, while in the first fixation region 22, the corresponding guide shaft is fixed to the chassis 12 by use of a different mechanism. In the first fixation region 22, fixation members are formed by protruding parts of the chassis 12 in a direction of the thickness of the chassis 12, and a position of the end portion of the first guide shaft 14 is fixed by use of a repulsive force which is produced by the elastic deformation or the plastic deformation of the fixation members. This scheme is a gist of the embodiment, and will be later described while referring to FIG. 4.

The spindle motor 34 has a function of rotating the optical disc, which is held by a chucking mechanism, at a predetermined speed. The spindle motor 34 is fixed to the chassis 12 with the motor supporting member 36, which is formed from a metal plate in a predetermined shape, interposed in between. Incidentally, the spindle motor 34 is fixed to the motor supporting member 36 rotatably about its rotary axis.

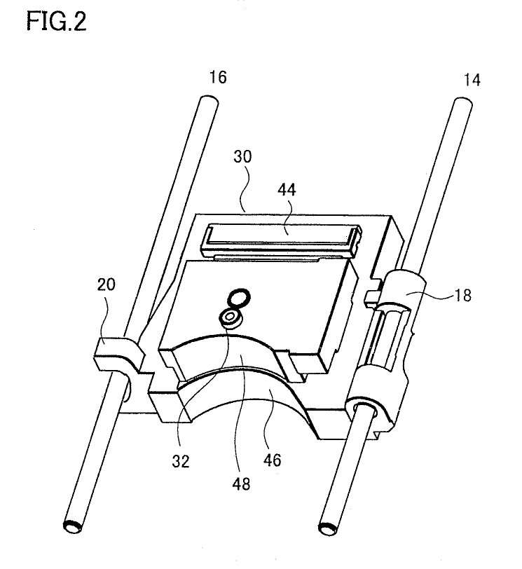

In the optical pickup device 30, a light-emitting chip, a light-receiving chip and the other optical elements are accommodated inside a housing which is molded out of a resin in a predetermined shape. Two near-end portions of the housing of the optical pickup device 30 are held movable in the radial direction of the optical disc by the first guide shaft 14 and the second guide shaft 16. Detailed descriptions will be later provided for this holding mechanism while referring to FIG. 2.

Referring to FIG. 1B, the first guide shaft 14, the second guide shaft 16 and a lead screw 38 are placed in parallel to one another. A guide groove is spirally formed in an outer surface of the lead screw 38. An end of the lead screw 38 is connected to a thread motor 40. On the other hand, front end portions of an engagement portion 42 fixedly attached to the housing of the optical pickup device 30 are biased in order to engage with the groove of the lead screw 38. Thus, once a tracking signal is applied to the thread motor 40, the lead screw 38 is rotated at a predetermined angle. Hence, a force for moving the engagement portion 42 in an axial direction of the lead screw 38 acts on the engagement portion 42 engaging with the guide groove of the lead screw 38. By this, the optical pickup device 30 fixed to the engagement portion 42 moves a predetermined distance while supported by the first guide shaft 14 and the second guide shaft 16.

Referring to FIG. 2, the optical pickup device 30 includes: a housing 46; an actuator 48 fixedly attached to the upper surface of the housing 46, and supporting an objective lens 32; a connector 44 serving as an input/output terminal of the optical pickup device 30; and a guide hole 18 and a guide groove 20 respectively provided to both the right and left ends of the housing 46.

The guide hole 18 is a hole portion provided by integrally injection-molding the housing 46 and the guide hole 18 out of a resin material. The first guide shaft 14 is inserted in the guide hole 18. The guide hole 18 not only supports the optical pickup device 30 while allowing the optical pickup device 30 to move in the radial direction of the optical disc, but also has a function of restraining the optical pickup device 30 from moving in a direction orthogonal to this radial direction. To this end, the inner diameter of the guide hole 18 is set large enough for the guide hole 18 to allow the optical pickup device 30 to move in a direction along the first guide shaft 14, and concurrently to restrain the optical pickup device 30 from rattling.

It should be noted that the various optical elements accommodated in the housing 46 are connected to a main circuit board built in the case of the optical disc apparatus via the connector 44 and a flexible wiring board (not illustrated).

The guide groove 20 is provided in an end portion of the housing 46, which is opposed to the guide hole 18. The guide groove 20 is shaped like the letter U or a square bracket, and is opened outward. The second guide shaft 16 engages with or is inserted in the guide groove 20.

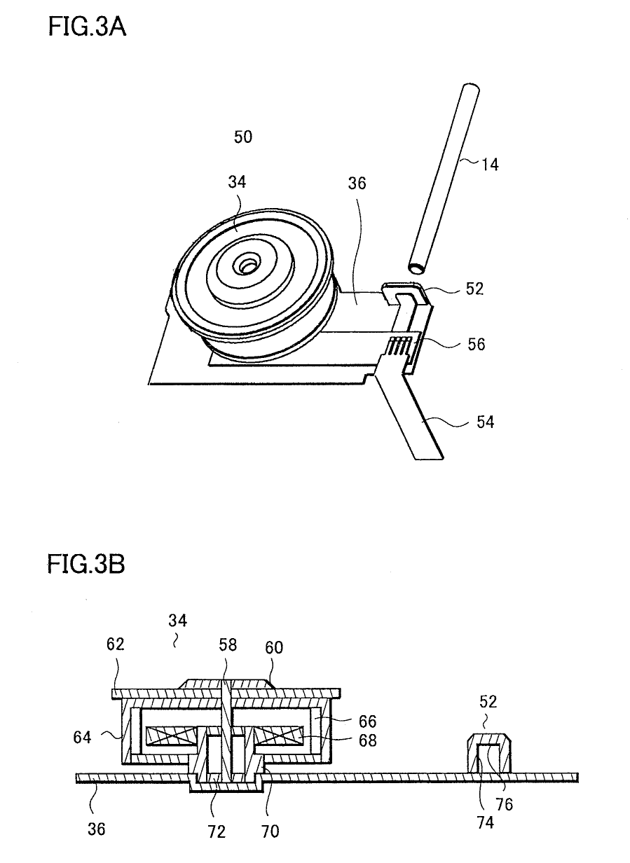

Next, referring to FIGS. 3A and 3B, descriptions will be provided for a configuration of a motor unit 50 installed in the optical pickup supporting device 10. FIG. 3A is a perspective view showing the motor unit 50. FIG. 3B is a cross-sectional view of the motor unit 50.

Referring to FIG. 3A, the motor unit 50 includes: the motor supporting member 36 formed from the metal plate in the predetermined shape; the spindle motor 34 rotatably fixed to this motor supporting member 36; and a position regulating portion 52 for regulating the position of the first guide shaft 14. In addition, a motor board 56 and a flexible wiring board 54 are arranged on the upper surface of the motor supporting member 36. Wirings through which an electric current for driving the spindle motor 34 flows are provided to the motor board 56. The flexible wiring board 54 is connected to the wirings of the motor board 56. Furthermore, multiple hole portions used to fix the motor supporting member 36 to the chassis are provided to the motor supporting member 36.

Referring to FIG. 3B, descriptions will be provided for a configuration of the spindle motor 34. A rotary shaft supporting member 70 is fixed to a recess portion obtained by recessing a part of the motor supporting member 36. Multiple driving coils 68 are fixed to the rotary shaft supporting member 70. In addition, a bearing 72 is built in the rotary shaft supporting member 70. A bearing 72 is fixedly attached to the rotary shaft supporting member 70, and rotatably supports a rotary shaft 58 of the spindle motor 34. In this respect, the rotary shaft supporting member 70 may be arranged in a hole which is provided in the motor supporting member 36.

A rotor 64 is fittingly fixed to the rotary shaft 58, and rotates integrally with the rotary shaft 58. Furthermore, a ring-shaped magnet 66 is adhesively fixed to the inner surface of the rotor 64. A turntable 62 constitutes a surface which the main surface of the optical disc is in contact with. The turntable 62 rotates together with the rotor 64. A centering member 60 has a chucking function. When a hole portion provided in the center portion of the optical disc is fitted to the centering member 60, a position of the optical disc in the direction of the main surface is defined as a predetermined position.

In the thus-configured spindle motor 34, once a drive signal is supplied to the driving coils 68 from a motor driving circuit installed in the motor board 56 and the like, a rotary force to be applied to the rotor 64 is generated by a magnetic force induced from the driving coils 68 and a magnetic force produced from the magnet 66. By this, the rotor 64 rotates about the rotary shaft 58.

Once the rotary shaft 58 rotates due to the rotary driving force produced in the rotor 64, the turntable 62 fittingly fixed to the rotary shaft 58 rotates. Accordingly, the optical disc placed on the turntable 62 can be rotated. Subsequently, when the amplitude of the drive signal supplied to the driving coils 68 and the interval of drive pulses supplied to the driving coils 68 are controlled, the rotational speed of the optical disc can be controlled in order to set the rotational speed thereof at a desired rotational speed.

Referring to FIG. 3A, the position regulating portion 52 is a part obtained by folding an end portion of the motor supporting member 36 formed from the metal plate at a right angle. The position regulating portion 52 is provided with a penetration portion in which the first guide shaft 14 can be inserted. Referring to 3B, the internal sides of the position regulating portion 52 include: a first position regulating portion 74 which is a left side as shown on the sheet on which the drawing is made; and a second position regulating portion 76 which is an upper side as shown on the sheet. Thus, the first guide shaft inserted in the position regulating portion 52 is pressed by the first position regulating portion 74 and the second position regulating portion 76. Thereby, the position of the first guide shaft 14 is regulated.

In this configuration, the position of the turntable 62 is determined by the bearing 72 fixedly attached to the rotary shaft supporting member 70 which is fixed to the recess portion formed in the motor supporting member 36. On the other hand, the position of the first guide shaft 14 for positioning the optical pickup device is regulated by the position regulating portion 52 which is a part of the motor supporting member 36. Thus, the position of the spindle motor 34 and the position of the first guide shaft 14 are regulated by the motor supporting member 36 which is the single continuous metal plate. This much enhances the relative positional accuracy between the spindle motor 34 and the first guide shaft 14 in the vertical direction and the left-right direction as shown on the sheet on which the drawing is made. Accordingly, the relationship between the optical pickup device whose movement position is regulated by the first guide shaft 14 and the optical disc placed on the turntable 62 rotationally driven by the rotary shaft 58 are maintained in an optimal condition.

Referring to FIGS. 4A to 4E, descriptions will be provided for a structure where, in the first fixation region 22, the first guide shaft 14 is fixed to the chassis 12. FIG. 4A is a perspective view showing a structure of the chassis 12 in the first fixation region 22. FIG. 4B is a perspective view showing the structure in which, in the first fixation region 22, the first guide shaft 14 is fixed to the chassis 12. FIG. 4C is a cross-sectional view of the structure taken along the C line of FIG. 4B. FIG. 4D is a cross-sectional view of the structure taken along the D line of FIG. 4B. FIG. 4E is a cross-sectional view of the structure taken along the E line of FIG. 4B.

Referring to FIG. 4A, a fixation area 78 formed integrally with the chassis 12 is provided in a part of the chassis 12 corresponding to the first fixation region 22 to which the guide shaft is fixed. Because, as described above, the chassis 12 is injection-molded out of the resin material such as a polycarbonate resin, the fixation area 78 is formed as a protruding area integrally protruding from the upper surface of the chassis 12.

To put is specifically, the fixation area 78 includes a first fixation member 80, a guide portion 84, a second fixation member 82 and a contact member 86. The first fixation member 80 and the second fixation member 82 pressingly fixes the first guide shaft 14 to the position regulating portion 52 of the motor supporting member 36 by use of repulsive forces produced by their own deformation.

The guide portion 84 is shaped like the letter L which is placed upside down, and is arranged adjacent to the first fixation member 80. The guide portion 84 has a function of facilitating the insertion of the first guide shaft 14 during the manufacturing step. In addition, for the purpose of inserting the first guide shaft 14 smoothly, as shown in FIG. 4E, a lower end portion of the guide portion 84 which faces the inside of the apparatus is chamfered. The cross section of the guide portion 84 may be shaped like the letter C by this chamfering process. The scheme is similarly applied to the first fixation member 80. Furthermore, the guide portion 84 and the first fixation member 80 collectively form a rectangular frame.

The second fixation member 82 is a member obtained by protruding a part of the main surface of the chassis 12, which corresponds to a part through which the first guide shaft 14 is inserted. The second fixation member 82 is placed in a region interposed between the guide portion 84 and the contact portion 86. The second fixation member 82 gives a pressing force to the first guide shaft 14 from under.

The contact portion 86 is a member for positioning the first guide shaft 14 when the front end portion of the first guide shaft 14 comes into contact with the contact portion 86. The positioning of the first guide shaft 14 in its axial direction is achieved by the contact portion 86.

FIG. 4B is a perspective view showing a state in which the optical pickup device 30, the first guide shaft 14 and the motor unit 50 are mounted on the chassis 12.

A method of mounting these components on the chassis 12 is as follows.

First of all, the motor unit 50 is fixedly attached to the chassis 12 by use of screws inserted through the respective hole portions provided in the motor supporting member 36. Thereby, the position regulating portion 52 formed from the part of the motor supporting member 36 which is a metal plate, and the fixation area 78 of the chassis 12 injection-molded out of the resin material are stacked together in the first fixation region 22 in the direction of the axis of the first guide shaft 14.

Subsequently, the first guide shaft 14 is inserted through the guide hole 18 of the optical pickup device 30. Thereafter, the end portion of the first guide shaft 14 is inserted through the fixation area 78 and the position regulating portion 52. This insertion brings the front end portion of the first guide shaft 14 into contact with the contact portion 86 of the chassis 12, and makes the end portion of the first guide shaft 14 fixed to the first fixation region 22.

Referring to FIG. 1B, afterward, in the other fixation regions, the end portions of the guide shafts are fixed to the chassis 12. To put it specifically, in the second fixation region 24, the other end portion of the first guide shaft 14 is fixed to the chassis 12. Subsequently, in the third fixation region 26 and the fourth fixation region 28, the two ends of the second guide shaft are fixed to the chassis 12.

As shown in this drawing, the mechanisms with which the guide shafts are fixed to the chassis in the second fixation region 24 to the fourth fixation region 28 are different from the mechanism with which the guide shaft is fixed to the chassis in the first fixation region 22. In the first fixation region 22, the first guide shaft 14 is fixed to the predetermined position by the repulsive force produced by the protruding portion of the chassis 12. In the second fixation region 24 to the fourth fixation region 28, the guide shafts are fixed to the chassis 12 by the fastening mechanisms such as the screws. Furthermore, the positions of the guide shafts are adjusted by rotating the screws in order that the running plane of the optical pickup device 30 which is made by the first guide shaft 14 and the second guide shaft 16 can be in parallel to the main surface of the optical disc rotated by the spindle motor 34. When this adjustment is performed, the first fixation region 22 to which the first guide shaft 14 is already fixed is used as the reference point.

Through the foregoing steps, the first guide shaft 14 and the second guide shaft 16 are fixed to the respective predetermined positions of the chassis 12.

Referring to FIGS. 4C to 4E, descriptions will be provided for a structure in which the end portion of the first guide shaft 14 is positioned to a predetermined position in the first fixation region 22. In this respect, as described above, when the end portion of the first guide shaft 14 is inserted through the fixation area 78 of the chassis 12 and the position regulating portion 52 of the motor supporting member 36, the first guide shaft 14 is pressingly fixed to the position regulating portion 52 by the repulsive force from the fixation area 78.

Referring to FIG. 4C, the first fixation member 80 of the chassis 12 bends within an elastic deformation range rightward as shown on the sheet on which the drawing is made. This causes a repulsive force for moving the first guide shaft 14 leftward as shown on the sheet. Thus, as shown in FIG. 4D, the first guide shaft 14 is pressed to the first position regulating portion 74 of the position regulating portion 52. Because the position regulating portion 52 including the first position regulating portion 74 is formed from the metal plate, the position regulating portion 52 does not deform even though the first guide shaft 14 is pressed by the repulsive force produced by the fixation area 78. Accordingly, when the first guide shaft 14 is pressingly fixed to the first position regulating portion 74, the position of the first guide shaft 14 in the lateral direction as shown on the sheet is regulated accurately.

Moreover, as shown in FIG. 4C, the lower surface of the first guide shaft 14 is in contact with the second fixation member 82 obtained by protruding a part of the upper surface of the chassis 12. Thus, when the second fixation member 82 is pressed by the lower surface of the first guide shaft 14, an apex portion of the second fixation member 82 is partially crushed due to its plastic deformation. This causes a repulsive force for pushing the first guide shaft 14 upward. This repulsive force presses the first guide shaft 14 to the second position regulating portion 76 shown in FIGS. 4D and 4E. Because the upper end portion of the first guide shaft 14 is pressingly fixed to the second position regulating portion 76 of the position regulating portion 52 formed from a thick metal plate, the position of the first guide shaft 14 in the vertical direction as shown on the sheet on which the drawings are made is regulated accurately.

In the embodiment, as described above, the position of the first guide shaft 14 is fixed by use of the repulsive force produced by the elastic deformation or the plastic deformation of the fixation area 78 formed from the flexible resin material. Accordingly, referring to FIG. 4B, even though vibrations occur due to the rotation of the spindle motor 34, the vibrations are absorbed by the deformation of the fixation area 78, and the vibrations are thus restrained from being transmitted to the first guide shaft 14 and the optical pickup device 30. Consequently, the optical pickup device 30 is restrained from malfunctioning due to the vibrations caused by the rotation of the spindle motor 34. In addition, noises caused by the vibrations of the spindle motor 34 are reduced for the same reason.

Moreover, in the embodiment, the position of the end portion of the first guide shaft 14 is regulated by the position regulating portion 52 formed from the metal plate. The position regulating portion 52 formed from the metal plate has a higher mechanical strength and a smaller coefficient of thermal expansion than the chassis 12 formed from the resin material. Accordingly, the position of the first guide shaft 14 is regulated more accurately.

Additionally, the position regulating portion 52 for regulating the position of the first guide shaft 14 is the part of the motor supporting member 36, and the spindle motor 34 is fixed to this motor supporting member 36. Accordingly, the position of the spindle motor 34 and the position of the first guide shaft 14 are accurately regulated by the single metal plate. This enhances the relative positional accuracy between the optical disc rotated by the spindle motor 34 and the optical pickup device whose position is determined by the first guide shaft 14.

Furthermore, the fixation area 78 is the part of the chassis 12, and the position regulating portion 52 is the part of the motor supporting member 36. This makes it possible to regulate the position of the first guide shaft 14 with higher accuracy by use of no specialized parts.

What is claimed is:

1. An optical pickup supporting device comprising:
a chassis;
an optical pickup device for projecting laser light on an optical recording medium, and detecting the laser light reflected off the optical recording medium;
a first guide shaft inserted through a guide hole provided in the optical pickup device, two near-end portions of the first guide shaft being fixed to the chassis;
a second guide shaft inserted through a guide groove provided in the optical pickup device, two near-end portions of the second guide shaft being fixed to the chassis; and
a motor supporting member for rotatably fixing a spindle motor to the chassis, the spindle motor being configured to rotate the optical recording medium, wherein
one of the two near-end portions of the first guide shaft is pressingly fixed to a position regulating portion by use of a fixation area continuing integrally with the chassis, the position regulating portion provided in the motor supporting member.

2. The optical pickup supporting device of claim 1, wherein:
the fixation area of the chassis includes a first fixation portion for pressing the first guide shaft in a first direction, and a second fixation portion for pressing the first guide shaft in a second direction orthogonal to the first direction; and
the position regulating portion of the motor supporting member includes a first position regulating portion for regulating movement of the first guide shaft in a third direction opposite to the first direction, and a second position regulating portion for regulating the movement of the first guide shaft in a fourth direction opposite to the second direction.

3. The optical pickup supporting device of claim 2, wherein
the first guide shaft is pressed to the first position regulating portion of the motor supporting member by a repulsive force produced by elastic deformation of the first fixation portion.

4. The optical pickup supporting device of claim 2, wherein
the first guide shaft is pressed to the second position regulating portion of the motor supporting member by a repulsive force produced by plastic deformation of the second fixation portion.

5. The optical pickup supporting device of claim 1, wherein
the chassis including the fixation area is injection-molded out of a resin material.

6. The optical pickup supporting device of claim 1, wherein
a relative position between the spindle motor and the first guide shaft is regulated by contact of the first guide shaft with the position regulating portion of the motor supporting member.

7. An optical disc apparatus comprising the optical pickup supporting device of claim 1.
